(19) United States
(12) Patent Application Publication
(10) Pub. No.: US 2002/0151398 A1
(43) Pub. Date: Oct. 17, 2002

(54) Light metal pulleys having improved wear resistance

(75) Inventor: Brian W. Campbell, Brookline, MO (US)

Correspondence Address: DAYCO PRODUCTS, LLC, 1 PRESTIGE PLACE, MIAMISBURG, OH, 45342, US

(73) Assignee: Dayco Products, LLC, Dayton, OH

(21) Appl. No.: 09/833,781

(22) Filed: Apr. 12, 2001

(51) Int. Cl. F16H 55/36; F16H 55/48

(52) U.S. Cl. 474/166; 474/192

(57) ABSTRACT

A pulley having a ceramic-type metallic oxide working surface exhibiting a wear rate which is inversely proportional to the wear surface hardness of said coated wear surface is described.

### BACKGROUND OF THE INVENTION

The present invention relates to light metal pulleys having an improved wear surface for use with belts such as drive belts in automotive applications and particularly for use in driving an auxiliary machine, driven by an automobile engine.

Typically, pulleys are used to drive belt such as endless belts, e,.g., timing belts and belts for driving auxiliary machines, driven by automotive engines and are generally configured to provide an appropriate angle of the belt and impart a suitable tension to the belt.

Pulleys have long been known to be effective, when used in combination with a rope, cord, chain or the like, to effectively reduce the amount of applied force to move an object. It has also been known to use pulleys in combination with endless belts for transmitting motion continuously to various accessories on an automobile engine. For example, U.S. Pat. No. 6,102,822 to Nakazeki describes an arrangement of various pulleys which includes an endless belt entrained around a driving pulley fixed to a crank shaft, two driven pulleys fixed on corresponding cam shafts, a tensioner pulley rotatably mounted on a fixed shaft and an idler pulley to provide a timing belt arrangement in an automobile engine.

In view of the high compression engines in automobile manufacture today and the construction of the belts used to drive the various accessories and components of these engines, the wear surfaces of the pulley devices for transmitting the notion of the belts deteriorate at much faster rate than the ordinary pulley surface used in the past. For example, current cold-formed steel pulleys are generally adequate for about 95 percent of all applications, however, there are some conditions, such as abrasion resistance to sand particles, where even steel pulleys do not hold up Accordingly, there is a serious need in the industry for a pulley device which has an improved wear surface, is light in weight and resists corrosion.

### SUMMARY OF THE INVENTION

In accordance with the present invention a light metal pulley is provided which has an improved wear surface which is more resistant to the abrasive environment and recurring wear from drive belts and provides superior corrosion resistance as well.

The pulley of the present invention is fabricating by die casting, forming, extrusion or machining a light metal such as aluminum, magnesium, titanium or alloy blends thereof. The pulley is formed by producing a fabricated pulley blank and then applying a high electrical current to the pulley blank while it is submersed in an alkaline electrolyte solution. The pulley produced has an extremely hard, ceramic-type metal oxide coating on the working surface of the pulley. The hard ceramic-type metal oxide coated surface withstands wear beyond the capability of stamped steel, glass filled nylon, phenolic thermosets, powered metal or hardened powered metal. Furthermore, the pulleys of the present invention are much lighter than steel or powdered metal pulleys and have superior corrosion resistance.

A process for surface treatment of light metals such as aluminum, magnesium, titanium and alloys thereof is taught in WO 99/31303 and marketed by Isle Coat, Ltd., Castletown, Isle of Man. Such treated metals are useful in the automotive industry for the manufacture of pistons, cylinder blocks, sliding bearings, cylinder liners, exhaust manifolds, valve trains, suspension elements, fuel pumps, gearboxes, engine block covers, structural elements, wheels, axles, spindles, swivels, ratchets, and slides. Other applications include aerospace; textile industry; marine equipment; oil and gas industry; cookware; medicine; printing; packaging and tobacco industry; robotics; etc.

With respect to the improved hardness and wear resistance of the working surface of the pulleys of the present invention, it has been found that the surface wear rate is inversely proportional to the war surface hardness of the pulley.

### DESCRIPTION OF THE INVENTION

In accordance with the present invention, a light weight pulley having extraordinary surface hardness and corrosion resistance for use in the automobile industry for driving various accessories is described. The pulley is preferably used with an endless belt for providing the motion to drive the accessories. When in service the pulley, and in particular, the working surface of the pulley will be in contact with a belt such as an endless belt which is commonly used in the automotive industry to provide motion to drive certain accessories, for example a timing belt or an alternator. Typically the drive belt travels at speeds ranging from about 10 to 100 feet per second with a load on the pulley surface of up to about 200 ft-lbf. The belt is typically constructed from hard rubber or a rubber-impregnated fabric. The working conditions within an automobile engine compartment include ambient air and may also include contact with engine oil and/or coolant. Operating temperatures in such an environment are commonly in the range of about −40 degrees to about +250 degrees F. and may reach +300 degrees or even higher.

since the engine compartment is generally open to the surrounding atmosphere, the various parts are continually subjected to dirt, sand, water and other extraneous materials found on highways and on open roads. Sand particles in particular become embedded in or on the surface of the belts, and as the belts contact the surface of the pulley, often in a sliding relationship, the working surface of the pulley is damaged to the point where its usefulness is compromised. Therefore, it is extremely important that the working surface of the pulley is hard enough to maintain its integrity over several years. The pulleys of the present invention has an extremely hard ceramic-type metal oxide coating on the wear surface thereof. The coating results from plasma oxidation of the working surface of the pulley by subjecting at least the working surface of the pulley to a high electric current while the working surface is submerged in an alkaline electrolyte. In order to provide the desired hardness, the wear surface of the pulley of the present invention is subjected to a current density of at least about 12 amps/100 square cm or about 4.5 KW per pulley.

The ceramic-type metal oxide coating results from subjecting the pulley or at least the working surface of the pulley, to an electric current while the pulley or surface thereof is submerged in an electrolyte solution, for example, an alkaline electrolyte which comprises an aqueous solution of an alkaline metal hydroxide, an alkaline metal silicate, an alkaline metal pyrophosphate, and a peroxide compound. Preferably, the alkaline electrolyte contains about 1 to 5 g/l of the alkaline metal hydroxide, about 2 to 15 g/l of the alkaline metal silicate, about 2 to 20 g/l of the alkaline metal pyrophosphate, and about 2 to 7 g/l of the peroxide compound

The thickness of the ceramic-type metal oxide coating on the wear surface of the pulley of the present invention is not critical; however, it should be of a sufficient thickness to provide the hardness and abrasion resistance desired and not so overly thick to be cost prohibitive, typically, the coating will have a thickness up to about 100 microns or more, depending on the application of the pulley. Thicknesses of about 30 to 100 microns have been found to be useful in most applications.

The pulleys of the present invention are manufactured from fabricated light metal pulley blanks. The light metals useful in manufacturing the pulleys of the present invention include aluminum, magnesium, titanium and the like, and alloys thereof. The light metal blanks are subsequently subjected to a high electrical current while the pulleys, or at least the wear surfaces of the pulleys, are submerged in an electrolyte solution. In one aspect of the invention, the pulleys are nested upon racks so that only the exposed working surface of the pulley is subjected to the treatment. In the long run, and in the overall scheme of providing the improved pulleys of the present invention, it may be more practical to subject the entire pulley to the electrolyte solution while applying the electric current.

While the pulley of the present invention is described herein as having certain characteristics, it will be obvious to those skilled in the art that certain modifications may be made without departing from the scope and spirit of the invention as indicated by the scope of the appended claims.

What is claimed is:

1. A pulley having a ceramic-type coated wear surface exhibiting a wear rate which is inversely proportional to the wear surface hardness of said coated wear surface, said pulley having been treated with high electrical current while at least the wear surface of said pulley is submerged in an electrolyte solution to form said metallic oxide coating thereon.

2. The pulley of claim 1 wherein said pulley is fabricated from a light metal selected from the group consisting of aluminum, titanium, magnesium and alloy thereof.

2. The pulley of claim 1 wherein said light metal is aluminum.

3. The pulley of claim 1, wherein said pulley is fabricated by die-casting, extrusion, forming or machining said light metal.

4. The pulley of claim 1, wherein said electrolyte is an alkaline electrolyte.

5. The pulley of claim 5, wherein said electrolyte is an alkaline electrolyte comprising about 1 to 5 g/l of an alkaline metal hydroxide, about 2 to 15 g/l of an alkaline metal silicate, about 2 to 20 g/l of an alkaline metal pyrophosphate, and about 2 to 7 g/l of a peroxide.

6. The pulley of claim 1, wherein said electrical current has a current density of at least about 12 amps/100 square cm.

7. The pulley of claim 7, wherein said electrical current has a current density of about 12 to 16 amps/100 square cm.

8. The pulley of claim 1, wherein said ceramic type coating is a metallic oxide coating.

9. The pulley of claim 9, wherein said coating has a thickness of about 30 to 100 microns.

10. The pulley of claim 1, in combination with an elastomeric member for applying force on an element.

12. The pulley of claim 11, wherein said elastomeric member is a belt.

13. Pulley of claim 11, wherein said combination is used for motion transmission for accessories for a motor vehicle.

14. A light metal pulley having a ceramic-type metallic oxide coated wear surface exhibiting a wear surface rate which is inversely proportional to the wear surface hardness of said coated wear surface, wherein said metallic oxide coating has a coating thickness of about 30 to 100 microns, said pulley having been treated with an electrical current having a current density of al least about 12 amps/square meter while at least the wear surface of said pulley is submerged in an alkaline electrolyte solution to form said ceramic-type metallic oxide coating thereon.

15. The pulley of claim 14, wherein said pulley is fabricated from a light metal selected from the group consisting of aluminum, titanium, magnesium and alloys thereof.

16. The pulley of claim 15 wherein said light metal is aluminum.

17. The pulley of claim 14, wherein said pulley is fabricated by die-coating, extrusion, forming or machining said metal.

18. The pulley of claim 14, wherein said alkaline electrolyte comprises about 1 to 5 g/l of an alkaline metal hydroxide, about 2 to 15 g/l of an alkaline metal silicate, about 2 to 20 g/l of an alkaline metal pyrophosphate, and about 2 to 7 g/l of a peroxide.

19. The pulley of claim 14, wherein said electrical current has a current density of about 12 to 16 amps/100 square cm.

20. In an aluminum pulley for use with a belt for transmission of motion to accessories for a motor vehicle, the improvement, wherein said pulley has a ceramic-type metal oxide coated wear surface having a thickness of about 30 to 100 microns, said metal oxide coating exhibiting a wear rate which is inversely proportional to the wear surface hardness of said coated wear surface and, wherein said pulley has been treated with an electrical current having a current density of about 12 to 16 amps/100 square cm while at least the wear surface of said pulley is submerged in an alkaline electrolyte solution consisting of about 1 to 5 g/l of an alkaline metal hydroxide, about 2 to 15 g/l of an alkaline metal silicate, about 2 to 20 g/l of an alkaline metal pyrophosphate and about 2 to 7 g/l of a peroxide to form said ceramic like metallic oxide coating thereon.
